(19) United States
(12) Patent Application Publication
(10) Pub. No.: US 2022/0040560 A1
(43) Pub. Date: Feb. 10, 2022

(54) WAN

(71) Applicant: LeTourneau University, Longview, TX (US)

(72) Inventor: Curtis Lawrence Wesley, Longview, TX (US)

(73) Assignee: LeTourneau University, Longview, TX (US)

(21) Appl. No.: 17/387,475

(22) Filed: Jul. 28, 2021

Related U.S. Application Data
(60) Provisional application No. 63/061,411, filed on Aug. 5, 2020.

(51) Int. Cl. A63F 1/02; G09B 1/34; G09B 19/00

(52) U.S. Cl. CPC A63F 1/02; G09B 19/00; G09B 1/34

(57) ABSTRACT

WAN is a child friendly educational card game that can be used to teach the concepts of trigonometric functions and identities or can be played as a simple card game by anyone over seven years old. The game uses all six basic trigonometric functions and their squares. These trigonometric functions are represented by various shapes and colors on the cards. Mathematical operations are determined by how the cards are placed. The game is played by creating card hands representing functions and operations that equal the number one. These card hands are called WAN hands.

### CROSS-REFERENCE TO RELATED APPLICATION

The present application claims priority to, and the benefit of, U.S. Provisional Application No. 63/061,411, which was filed on Aug. 5, 2020, and is incorporated herein by reference in its entirety.

### FIELD OF THE INVENTION

The present invention relates to the general field of card games. More specifically the present invention relates to card games in which players develop mathematical skills in trigonometry. The invention herein is both a stand-alone card game as well as a system to develop skills in trigonometry. The invention's effectiveness as a system to develop skills in trigonometry is due to the invention's architecture as a stand-alone card game that makes no reference to mathematics or trigonometry.

### BACKGROUND

Teaching trigonometric functions to anyone, especially children, has many challenges. Teaching is itself challenging and teaching a mathematics related topic only compounds the difficulties. Given that US learning outcomes, especially in mathematics, are not good, there has existed a long-felt need for resources that effectively engage the teaching of mathematical concepts. Because games are entertaining and engaging, they have been used to engage students in learning; however, the use of games to teach mathematics has had limited success.

Currently available trigonometric games are very complicated and difficult to play. There is often a need to memorize different formulae and values. Most of the games cannot be played without previous knowledge of some of the mathematical concepts. While students may play these games in a classroom setting, under the direction of a teacher, it is highly unlikely that students, or anyone else, will play these games outside of the classroom.

Given that currently available games only engage students during formal academic settings, they have a limited effectiveness in teaching trigonometry. A game would be significantly more effective if the student would engage with the game outside of the formal academic settings. There exists a long-felt need for a game that is easy, even for elementary students, enjoyable, and cannot be perceived to be associated with the academic subject being taught. Such a game would be played outside of the classroom setting as a stand-alone game, and; therefore, would increase engagement and learning of students who are unaware that they are being taught a mathematical concept.

### BRIEF SUMMARY OF THE INVENTION

The invention herein, WAN, is an enjoyable game best utilized when a person has no prior knowledge about the mathematics behind the game or knowledge that the game is related to mathematics. Persons playing WAN will not realize that they are playing anything other than a card game. WAN requires no prior knowledge of trigonometry. It embodies the concepts of trigonometric identities without the technical jargon, alleviating mathematical anxiety, and allowing players to unknowingly assimilate complex ideas.

WAN intentionally obscures the trigonometric functions and operations of trigonometry such that even young children can play, while still maintaining a complexity allowing players who know the meaning behind the cards to enjoy the mathematical challenge. Engagement; and therefore, also learning, is increased over the currently available games by providing an enjoyable game which is not recognizable as a mathematics teaching system. People of all ages will play the game for the fun and enjoyment of the game alone.

The present invention focuses only on trigonometric identities; however, the nature of the present invention can also be applied to other topics within mathematics or outside of mathematics. The principle of using a game that is enjoyable to play and does not reveal itself to be an educational tool, can be applied to teaching any topic. The embodiments disclosed herein, relating to trigonometry, are not intended to limit the scope of the invention and should be considered only an example of how the present invention can be applied by those skilled in the art.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

The embodiments herein will be better understood from the following detailed description with reference to the drawings in which:

FIG. 1 illustrates cards representing the sine function and the cosine function, the sine function is represented as a single green ellipse and the cosine function as a single red triangle, both the green ellipse of the sine function and the red triangle of the cosine function are on a white background, the shape, color, and the background color comprise a sine card and a cosine card;

FIG. 2 illustrates cards representing the cosecant function and the secant function, the cosecant function card is represented as a single white ellipse on a green background and the secant function card is represented as a white triangle on a red background, the colors being inverted from the colors used for the sine function card and the cosine function card;

FIG. 3 illustrates cards representing the squares of functions, the sine function card is comprised of a single green ellipse on a white background and the square of the sine function card is comprised of two green ellipses on a white background; likewise, the cosine function card is comprised of a single red triangle on a white background and the square of the cosine function card is comprised of two red triangles on a white background;

FIG. 4 illustrates cards representing the squares of functions, the cosecant function card is comprised of a single white ellipse on a green background and the square of the cosecant function card is comprised of two white ellipses on a green background; likewise, the secant function card is comprised of a white triangle on a red background and the square of the secant function card is comprised of two white triangles on a red background;

FIG. 5 illustrates cards representing the tangent function and the cotangent function. The tangent function is represented with a green ellipse, representing the sine function, above a red triangle, representing the cosine function, the triangle pointing away from the green ellipse; likewise, the cotangent is represented with red triangle above a green ellipse, the triangle pointing toward the green ellipse, as the cotangent is the inverse of the tangent;

FIG. 6 illustrates cards representing the square of the tangent function and the square of the cotangent function represented by cards having two green ellipses and two red triangles in like manner to the square of the sine and cosine functions;

FIG. 7 illustrates additional cards which can be used in place of the primary twelve playing cards, a green free card which can be used in place of green colored cards, a red free card which can used in place of red colored cards, and a free card which can be used in place of any of the twelve primary playing cards;

FIG. 8 illustrates how identical cards can be laid in a crossed or perpendicular placement, the cross or perpendicular placement representing division, wherein a function divided by itself will equal one and two identical cards played in a crossed or perpendicular placement represents one point in the game;

FIG. 9 illustrates how any card and its inverse, shown is the sine squared card and the cosecant squared card, can be laid on top of each other in a parallel placement, representing multiplication, wherein a function multiplied by its inverse equals one, such placement of a card on top of its inverse represents two points in the game;

FIG. 10 illustrates how trigonometric functions can be added representationally by laying cards next to each, the placement representing addition, in this example the addition of the square of the sine function with the square of the cosine function, the sum of which is one, such placement of a cards represents three points in the game;

FIG. 11 illustrates how trigonometric functions can be subtracted representationally by laying a card below another, in this example the square of the tangent function is laid below the square of the secant function, the difference of which is one, such placement of a cards represent three points in the game;

FIG. 12 illustrates how trigonometric functions can be subtracted representationally by laying a card below another, in this example the square of the cotangent function is laid below the square of the cosecant function, the difference of which is one, such placement of cards represents three points in the game;

FIG. 13 illustrates how trigonometric functions can be multiplied by laying a card on top of another card without crossing, as seen in this example of a cosine function card laid on top of a cosine function card to equal a square of the cosine function card, where the squares of the sine, secant, cosecant, tangent, and cotangent functions would be similarly represented; and,

FIG. 14 illustrates how the principle of multiplying functions can be used to make equivalent hands, as in the example of two tangent functions cards being used as an equivalent to the square of the tangent function card in the hand representing the square of the secant function less the square of the tangent function to equal one.

FIG. 15 illustrates a WAN-mo hand, obtained by playing two identical cards one below the other placed along side of any one of the three special WAN hand combinations as seen in FIG. 10, FIG. 11, and FIG. 12 or their equivalents, such placement of a cards represent four points in the game.

### DETAILED DESCRIPTION OF THE PRESENT INVENTION

The invention will now be described in detail in reference to the drawings, wherein like reference numbers are used to refer to like elements throughout. The invention is related to a method of teaching mathematical concepts. The embodiments described herein refer specifically to a card game; however, the invention could also be applied to other types of games such as two-dimensional and three-dimensional puzzles or any means that can represent elements in which elements can be combined in different ways. The embodiments described herein are not intended to limit the scope of the invention; rather, they are only a few of the embodiments possible to someone skilled in the art who understands the inventive concept.

The inventive concept is to represent mathematical functions and mathematical operations with elements and actions that are representative of, but not identifiable, as the mathematical functions or operations. Though there are many media that can be used as representative elements, the embodiment of the invention described herein has used playing cards as representative elements. The invention architecture is such that the playing cards have shapes and colors designed to be intuitively related to each other. The placements of the cards are representative of mathematical operations. The invention is such that the product of the functions resulting from the operations, as represented by the playing cards and the placements of the playing cards, can be intuitively grasped by users of all ages. Thus, players of the card game will be learning and using mathematics without realization. This invention architecture will become clear as we go through the detailed description of the drawings.

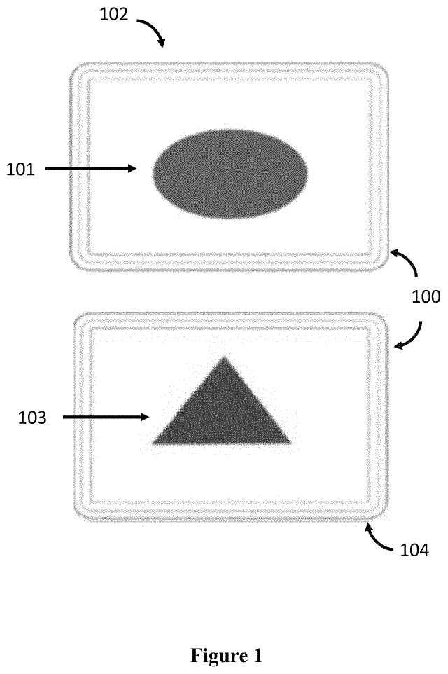

Referring now to the drawings, FIG. 1 illustrates two playing cards 102 and 104 of a plurality of playing cards 100. On playing card 102 there is a green ellipse 101 on what is otherwise a white background of playing card 102. Similarly, there is a red triangle 103 on playing card 104 on what is otherwise a white background. The green circle 101 and the red triangle 103 represent the sine function and the cosine function, respectively. The color and the shape are arbitrary, the shape and color are used to represent a trigonometric function. The card 102 and the card 104 become elements of a set that includes ten other elements that are intuitively related to the green ellipse 101 and the red triangle 103.

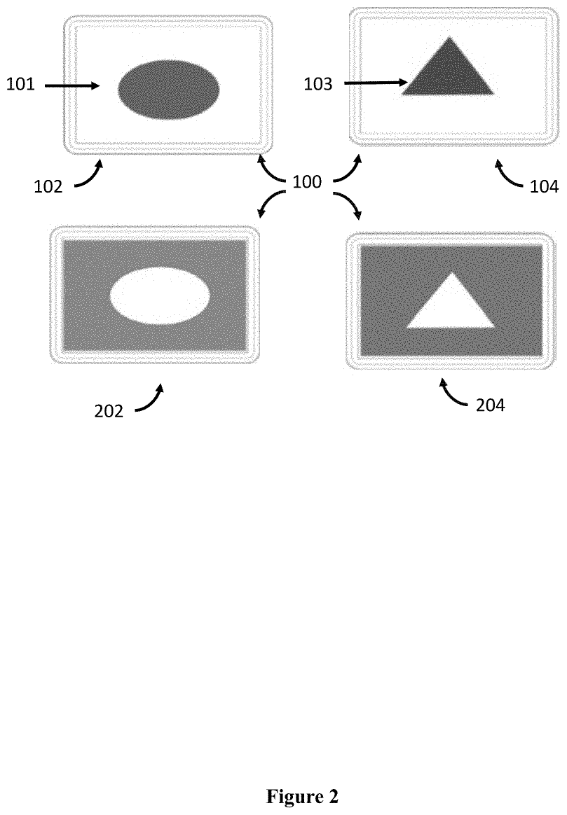

FIG. 2 illustrates the inverse elements, card 202 and card 204, of card 102 and card 104 of the plurality of playing cards 100. Card 202 displays the same shape as card 102 but is opposite in color—white shape on green background for card 202 and green shape on white background for card 102. Likewise, card 204 contains the same shape as card 104, but card 204 has a white shape on a red background while card 104 has a red shape on a white background. Though the green ellipse 101 and the red triangle 103 are arbitrary shapes and colors; the architecture of the invention is such that the shapes and colors of the inverse element cards 202 and 204 follow logically and the relationship is intuitively understood by users regardless of their knowledge or understanding of trigonometry. With respect to trigonometry, the inverse of the sine function, card 102, is the cosecant function as represented by card 202. The inverse of the cosine function, as represented by card 104, is the secant function, as represented by card 204.

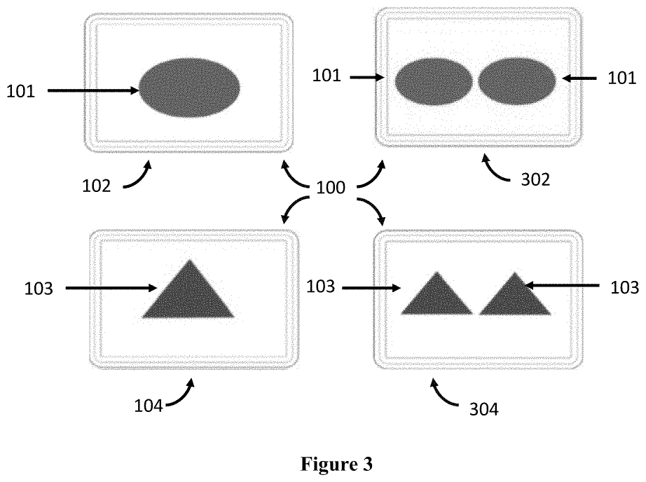

FIG. 3 illustrates additional cards in the plurality of playing cards 100. Card 102 is comprised of one green ellipse 101 and represents the sine function. Card 302 is comprised of two green ellipses 101 and represents the square of the sine function. Similarly, card 104 is comprised of one red triangle 103 and represents the cosine function and card 304 is comprised of two red triangles 103 and represents the square of the cosine function. Again, it is not necessary to know what mathematical relationship is being represented, as the logic of the invention's architecture is such that users will intuitively relate the function represented by card 102 with the function represented by card 302. It is not necessary to know or understand any mathematics or trigonometry to make the intuitive connections between card 102 and card 302; and likewise, the connection between card 104 and card 304.

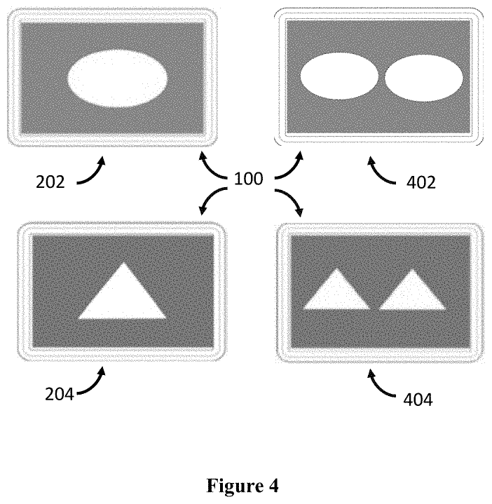

FIG. 4 illustrates how additional elements can be added to the plurality of playing cards 100 by logically expanding the card 202, representing the cosecant function, with card 402, representing the square of the cosecant function. Likewise, card 404 adds an element by expanding on card 204. Card 204 represents the secant function and card 404 represents the square of the secant function. Again, it is not necessary to know what each of the playing cards of the plurality of playing cards 100 represent mathematically, because the architecture of the invention allows users to draw an intuitive relationship between card 202 and card 402 as well as between card 204 and card 404.

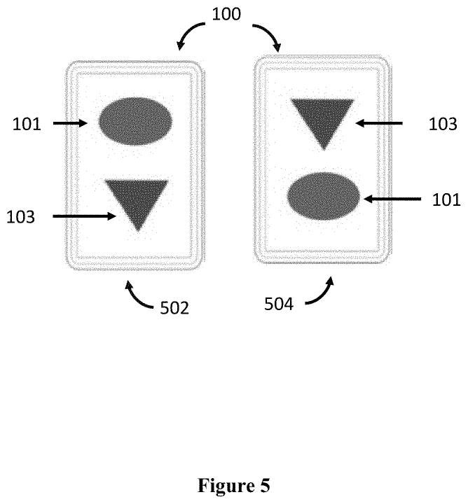

FIG. 5 illustrates how the combination of the green ellipse 101 and the red triangle 103 can be used to make a new element represented by card 502 and card 504 of the plurality of playing cards 100. The architecture of the invention will lead the user to intuitively see an inverse relationship between card 502 and 504, the inverse relationship having to do with positioning of shapes, the green ellipse 101 and the red triangle 103. Card 502 represents the tangent function and card 504 represents the cotangent function.

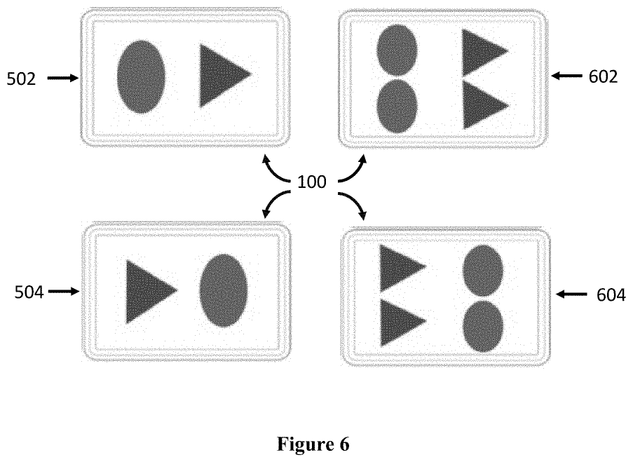

FIG. 6 illustrates an intuitive expansion to the plurality of cards 100, the doubling of the shapes present on card 502 to create card 602 draws the user to make an intuitive relationship between card 502 and 602. The same inventive architecture is applied to card 504 in the creation of card 604. Mathematically, card 602 represents the square of the tangent function while card 502 represents the tangent function. Similarly, card 604 represents the square of the cotangent function while card 504 represents the cotangent function. Again, the architect of the invention is such that the user intuitively makes relationships between the cards without the need of any knowledge or understanding of mathematics or trigonometry.

FIG. 1 through FIG. 6 illustrate the twelve elements of a set as represented by the plurality of playing cards 100 and construct the set of trigonometric functions consisting of: sine, cosine, cosecant, secant, tangent, cotangent, and the respective squares of each of these functions. Each element of the set has an inverse element.

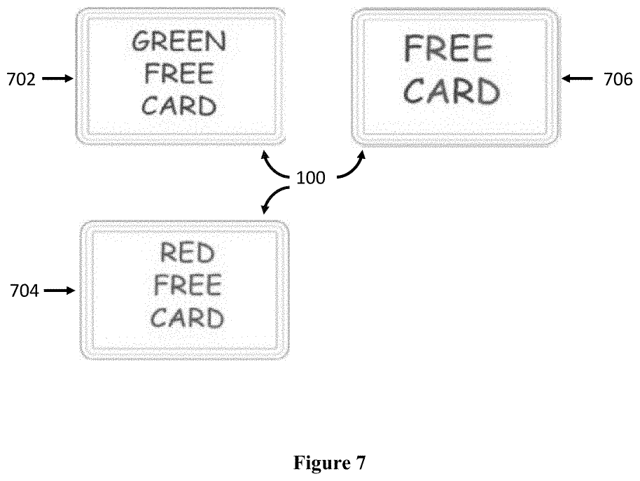

FIG. 7 illustrates three additional playing cards of the plurality of playing cards 100. Card 702, card 704, and card 706 do not represent additional elements to the set of twelve elements. Card 702 is a card that can be used as a substitute for any of the green cards; card 102, card 202, card 302, or card 402. Similarly, card 704 can be used as a substitute for any of the red cards; card 104, card 204, card 304, and card 404. Card 706 can be used a substitute for any card of the plurality of cards 100. Though card 702, card 704, and card 706 are three additional cards in the plurality of cards 100, the architecture of the invention is such that they do not represent additional elements to the set of elements, they are merely three different substitute cards for the existing twelve elements of the set.

In one embodiment of the invention the plurality of cards 100 are comprised of four copies of each of the twelve elements, two free cards, one free green card, and one free red card, for a total of 52 cards in the plurality of cards 100.

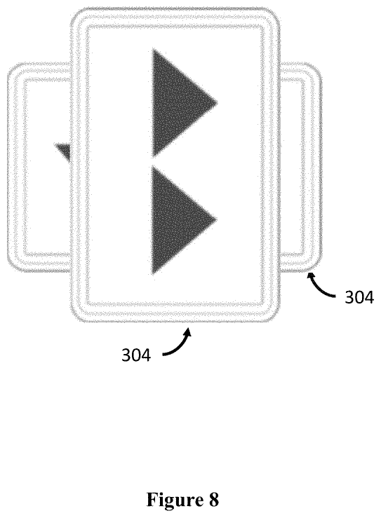

FIG. 8 illustrates two identical cards of card 304, one card placed on top of the other in a crossed or perpendicular pattern. The placement of the cards represents the rule of combination, or operation, on the elements of the set. In this case, the crossed or perpendicular placement represents division. Any element divided by itself will equal one. In the example illustration, card 304 represents the square of the cosine. The square of the cosine divided by the square of the cosine will equal one.

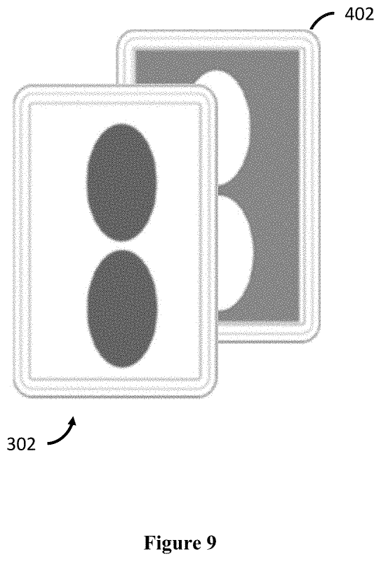

FIG. 9 illustrates another way to represent one. Card 402 is covered with card 302 without crossing the cards. Card 402 and card 302 are intuitively recognized as inverses of each other. An element multiplied by its inverse is one. This placement of one card on another card without crossing represents the rule of combination, or operation of, multiplication. FIG. 9 illustrates the multiplication of the square of the cosecant function by the square of the sine function, the product of which equals one. It should be understood that any combination of an element and its inverse with this card placement as a representation of a rule of combination, or operation, will equal one.

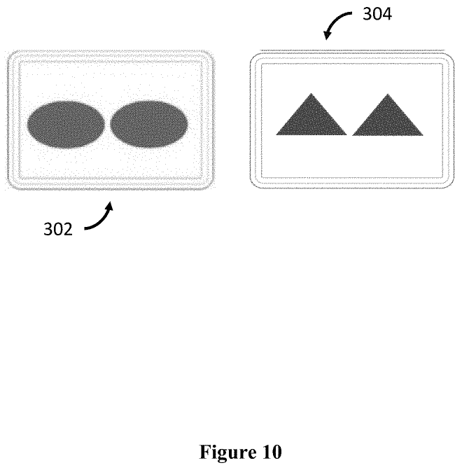

FIG. 10 illustrates the rule of combination, or operation, of addition. Card 304 is placed next to card 302, representing the square of the sine function plus the square of the cosine function, the sum of which equals one. This card placement is one of three special combinations that will discussed further herein.

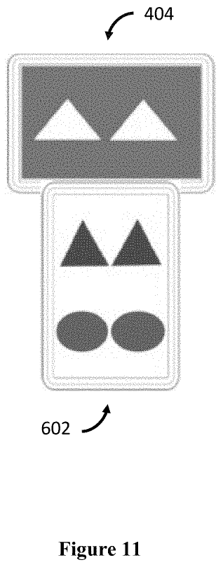

FIG. 11 illustrates the rule of combination, or operation, of subtraction. Card 602 is placed below card 404, intuitively a user will see this as the representative value of card 404 less card 602. Card 404 represents the square of the secant function, card 602 the square of the tangent function. The square of the secant minus the square of the tangent function is one. This card placement is one of three special combinations that will discussed further herein.

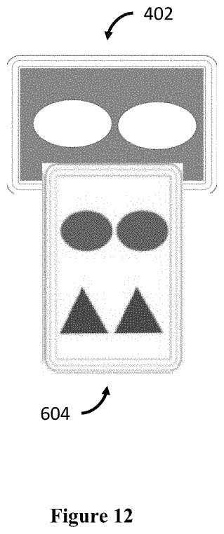

FIG. 12 illustrates the rule of combination, or operation of subtraction. Card 604 is placed below card 402, intuitively a user will see this as the representative value of card 402 less card 604. Card 402 represents the square of the cosecant function, card 604 the square of the cotangent function. The square of the cosecant minus the square of the cotangent function is one. This card placement is one of three special combinations that will discussed further herein.

The architecture of the invention has now been clearly described. The aim of the game is to produces hands, or combinations of cards corresponding to mathematical combinations of trigonometric functions, wherein the combinations of the functions equal to one. There are many such combinations as seen in Table 1 below. Table 1 provides a list of the basic trigonometric identities, the reciprocal identities, and the Pythagorean identities. All of these can be represented with cards from the plurality of cards 100 using the rules of combination for division, multiplication, addition, and subtraction as described herein. The architecture of the invention incorporates all the trigonometric identities illustrated in Table 1.

TABLE 1

| Basic Identities | |
|---|---|
| sin(θ) × sin(θ) = sin²(θ) | csc(θ) × csc(θ) = csc²(θ) |
| cos(θ) × cos(θ) = cos²(θ) | sec(θ) × sec(θ) = sec²(θ) |
| tan(θ) × tan(θ) = tan²(θ) | cot(θ) × cot(θ) = cot²(θ) |
| Reciprocal Identities | |
| csc(θ) = 1/sin(θ) | csc²(θ) = 1/sin²(θ) |
| sec(θ) = 1/cos(θ) | sec²(θ) = 1/cos²(θ) |
| cot(θ) = 1/tan(θ) | cot²(θ) = 1/tan²(θ) |
| sin(θ) × csc(θ) = 1 | sin²(θ) × csc²(θ) = 1 |
| cos(θ) × sec(θ) = 1 | cos²(θ) × sec²(θ) = 1 |
| tan(θ) × cot(θ) = 1 | tan²(θ) × cot²(θ) = 1 |
| sin(θ) ÷ sin(θ) = 1 | sin²(θ) ÷ sin²(θ) = 1 |
| cos(θ) ÷ cos(θ) = 1 | cos²(θ) ÷ cos²(θ) = 1 |
| tan(θ) ÷ tan(θ) = 1 | tan²(θ) ÷ tan²(θ) = 1 |

Pythagorean Identities
sin²(θ) + cos²(θ) = 1
sec²(θ) − tan²(θ) = 1
csc²(θ) − cot²(θ) = 1

As an example, FIG. 12 illustrates the third of the Pythagorean identities, playing card 402 placed above placing card 604. FIG. 10, FIG. 11, and FIG. 12 are the three Pythagorean identities and are three special playing hand combinations in the current invention.

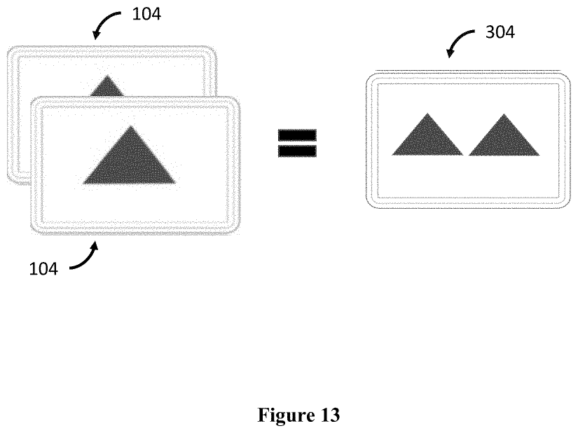

The elements in the trigonometric identities of Table 1 may be represented by one or multiple cards as seen in FIG. 13, wherein card 304 can be intuitively equated to two cards 104. Mathematically, the placement of card 104 on top of card 104 represents the rule of multiplication thereby representing the product of the sine function multiplied by the sin function, the square of the sine function, as represented by card 304. It will be appreciated that there are many such combinations of cards that can be used to equal another card.

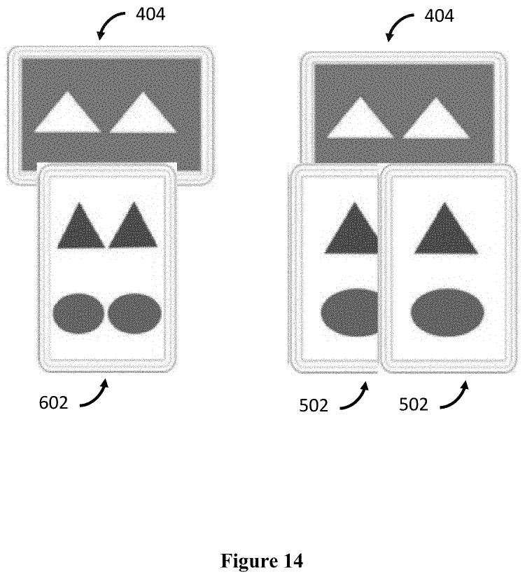

FIG. 14 illustrates another example of where two cards are used to represent one card. The left combination in FIG. 14 of card 404 above card 602 is representative of the square of the secant function less the square of the tangent function. Card 502 laid on top of another card 502 represents the product of the tangent function times the tangent function, the square of the tangent function, thereby equivalent to card 602. The architecture of the game is such that these combinations are intuitive to the user. Again, the user does not need any knowledge or understanding of mathematics or trigonometry to intuitively see the equivalence between the two sets of cards. Many such combinations are possible such that the examples shown should not be considered a complete list of such combinations.

The preferred embodiment has been described with playing cards as the means of representing mathematical functions. The playing cards of the present invention may be constructed of paper, laminated paper, wood, metal, plastic, or any other material that can be easily handled by a user. The playing cards may also be made with holes to represent the shapes and textures to represent the colors. The playing cards may also be three dimensional shapes constructed so the related functions fit into each other. The playing cards may also be represented virtually if the game is played on a computer. A person skilled in the art of games and mathematics will understand that are many embodiments of the present invention that would make use of the inventive architecture disclosed herein.

Given that the architecture of the invention has been fully described herein, whereby any person skilled in the art is enabled to construct the invention, we now describe the best mode of practice of the invention. A summary of this description will be included with the plurality of playing cards for users to reference.

In the preferred embodiment of the invention the plurality of playing cards 100 consists of four of each of the twelve primary cards 102 104 202 204 302 304 402 404 502 504 602 604 as illustrated in FIG. 1 through FIG. 6, one of the free cards 702 704 and two of the free card 706 as illustrated in FIG. 7, for a total number of 52 playing cards in the plurality of playing cards 100.

The goal of the game is to be the first to score seventeen points.

Play begins with the youngest and continues in a clockwise direction. After each game, the next oldest begins play, and so on. During each player's turn, the player must draw a card from either the discard pile or draw pile. The player may then choose to swap the card with one of their own, placing their own card on the discard pile, or they may or place the drawn card onto the discard pile. In either case, the player must put a card on the discard pile. This is called the draw phase.

After the draw phase, the player plays their WAN hand. The player must state the number of points earned during the hand or a penalty of 1 point may be assessed. The score keeper then tallies that players new score. This is called the WAN phase. The cards played during the WAN phase are then removed from the game and can only be used again when no more cards remain in the draw pile. A player can pass during the WAN phase.

Finally, the player draws from the draw pile until they again have five cards total in hand. This is called the redraw phase. The redraw phase ends the player's turn.

The next player clockwise then takes a turn and completes the three phases. The game continues until a player has scored 17 or more points.

In the case where all cards in the draw pile are used and no one has obtained 17 points, then the cards that have been put out of play are reshuffled. Play can then resume until 17 points are obtained.

The free cards 702 704 706 add excitement to the game by allowing users to substitute a free card for any of the other cards in the plurality of cards 100. The red free card 704 can replace any red card of the plurality of cards 100, and the green free card 702 can replace any green card of the plurality of cards 100 and the free card 706 can replace any card of the plurality of cards 100.

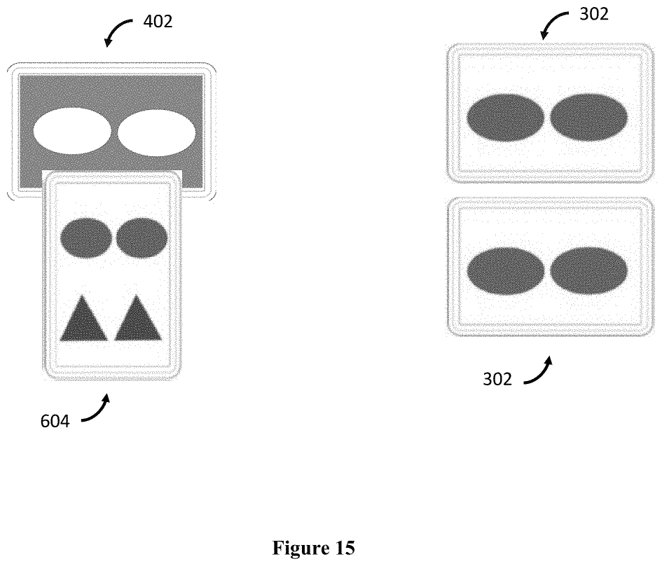

Card combinations that represent one have been described heretofore. The points earned by players for these card combinations are now described. Combinations that score one point include: any free card 702 704 706 played alone and two identical cards of the plurality of cards 100 placed in a crossed configuration as seen in FIG. 8. Combinations that score two points include: any two free cards 702 704 706 placed side by side, and any card of the plurality of cards 100 and its inverse, or opposite, placed on top of each other as seen in FIG. 9. Combinations that score three points include: any three free cards 702 704 706 placed side by side and any of the three special WAN hand combinations, or equivalents, seen in FIG. 10, FIG. 11, and FIG. 12. Combinations that score four points include: any four free cards 702 704 706 placed side by side and playing two identical cards one below the other placed along side of any one of the three special WAN hand combinations as FIG. 10, FIG. 11, and FIG. 12 or their equivalents, referred to as a WAN-mo hand, illustrated in FIG. 15.

FIG. 15 illustrates a WAN-mo hand. It shows card 604 placed below card 402 representing the square of the cosecant subtract the square of the cotangent. Along side is card 302 placed below card 302, representing the square of the sine function subtract the square of the sine function, or zero. The sum of the hand on the left and the hand on the right is one. Any two identical cards of the plurality of cards 100 may have been played on the right and any of the three special combinations representing the Pythagorean identities may have been played on the left.

What has been described above is the preferred embodiment of the claimed subject matter. It is, of course, not the only embodiment of the claimed inventive architecture. The inventive concept of using a card game comprised of playing cards representing trigonometric functions and placement of those cards as representing mathematical operations of those elements, can be embodied in numerous other combinations, permutations, and media that would be recognizable to one skilled in the art of mathematics and game development. Accordingly, the claimed subject matter is intended to embrace all such alterations, modifications and variations that fall within the spirit and scope of the claims herein.

We claim:

1. A system for teaching mathematics, comprising:
a plurality of elements wherein the elements are representative of mathematical functions;
a plurality of rules for combining at least two of the elements wherein the rules for combining at least two of the elements are representative of mathematical operations; and,
whereby the plurality of rules for combining at least two of the elements result in combinations representative of mathematical functions and mathematical identities.

2. The system for teaching mathematics of claim 1 wherein the plurality of elements is further comprised of a plurality of playing cards.

3. The system for teaching mathematics of claim 2 wherein the plurality of playing cards is further comprised of at least one card representative of each of the following mathematical functions: sin(θ), sin²(θ), cos(θ), cos²(θ), sec(θ), sec²(θ), csc(θ), csc²(θ), tan(θ), tan²(θ), cot(θ), and cot²(θ).

4. The system for teaching mathematics of claim 3 wherein the plurality of playing cards is comprised of green cards, red cards, and red and green cards;
wherein the green cards are further comprised of:
at least one card with a green ellipse on a white background representing the sin(θ) function;
at least one card with two green ellipses on a white background representing the sin²(θ) function;
at least one card with a white ellipse on a green background representing the csc(θ) function;
at least one card with two white ellipses on a green background representing the csc²(θ) function;
wherein the red cards are further comprised of:
at least one card with a red triangle on a white background representing the cos(θ) function;
at least one card with two red triangles on a white background representing the cos²(θ) function;
at least one card with a white triangle on a red background representing the sec(θ) function;
at least one card with two white triangles on a red background representing the sec²(θ) function;
wherein the red and green cards are further comprised of:
at least one card with a green ellipse and a red triangle, wherein the red triangle is pointed down and is below the green ellipse, on a white background representing the tan(θ) function;
at least one card with two green ellipses and two red triangles, wherein the two red triangles are pointed down and are below the green ellipses, on a white background representing the tan²(θ) function;
at least one card with a green ellipse and a red triangle, wherein the red triangle is pointed down and is above the green ellipse, on a white background representing the cot(θ) function; and,
at least one card with two green ellipses and two red triangles, wherein the two red triangles are pointed down and are above the green ellipses, on a white background representing the cot²(θ) function.

5. The system for teaching mathematics of claim 1 wherein the mathematical operations and the rules for combining at least two of the elements are representative of the mathematical operations are further comprised of:
addition, wherein the rule for combining is to place cards horizontally from left to right;
subtraction, wherein the rule for combining is to place cards vertically from top to bottom;
multiplication, wherein the rule for combining is to place one card on top of another in a parallel configuration; and,
division, wherein the rule for combining is to place cards on top of each other in a perpendicular configuration.

6. The system for teaching mathematics of claim 1 wherein the trigonometric identities are further comprised of:
the basic identities of trigonometry;
the reciprocal identities of trigonometry; and,
the Pythagorean identities of trigonometry.

7. The system for teaching mathematics of claim 6 wherein the combination of elements representing trigonometric identities are further comprised of:
a card combination of sin(θ) and sin(θ) and a rule of combination for multiplication representing sin²(θ);
a card combination of cos(θ) and cos(θ) and a rule of combination for multiplication representing cos²(θ);
a card combination of tan(θ) and tan(θ) and a rule of combination for multiplication representing tan²(θ);
a card combination of csc(θ) and csc(θ) and a rule of combination for multiplication representing csc²(θ);
a card combination of sec(θ) and sec(θ) and a rule of combination for multiplication representing sec²(θ); and,
a card combination of cot(θ) and cot(θ) and a rule of combination for multiplication representing cot²(θ).

8. The system for teaching mathematics of claim 7 wherein the combination of elements representing trigonometric identities are further comprised of combinations representing one:
a card combination of sin(θ) and sin(θ) and a rule of combination for division;
a card combination of cos(θ) and cos(θ) and a rule of combination for division;
a card combination of tan(θ) and tan(θ) and a rule of combination for division;
a card combination of cot(θ) and cot(θ) and a rule of combination for division;
a card combination of csc(θ) and csc(θ) and a rule of combination for division;
a card combination of sec(θ) and sec(θ) and a rule of combination for division;
a card combination of sin²(θ) and sin²(θ) and a rule of combination for division;
a card combination of cos²(θ) and cos²(θ) and a rule of combination for division;
a card combination of tan²(θ) and tan²(θ), and a rule of combination for division;
a card combination of cot²(θ) and cot²(θ) and a rule of combination for division;
a card combination of sec²(θ) and sec²(θ) and a rule of combination for division;
a card combination of csc²(θ) and csc²(θ) and a rule of combination for division;
a card combination of sin(θ) and csc(θ) and a rule of combination for multiplication;
a card combination of cos(θ) and sec(θ) and a rule of combination for multiplication;
a card combination of tan(θ) and cot(θ) and a rule of combination for multiplication;
a card combination of sin²(θ) and csc²(θ) and a rule of combination for multiplication;
a card combination of cos²(θ) and sec²(θ) and a rule of combination for multiplication;
a card combination of tan²(θ) and cot²(θ) and a rule of combination for multiplication;
a card combination of sin²(θ) and cos²(θ) and a rule of combination for addition;
a card combination of sec²(θ) and tan²(θ) and a rule of combination for subtraction; and,
a card combination of csc²(θ) and cot²(θ) and a rule of combination for subtraction.

9. The system for teaching mathematics of claim 8 wherein the plurality of playing cards is further comprised of at least one free card that can be used to substitute for another card in the plurality of playing cards.

10. The system for teaching mathematics of claim 9 wherein the plurality of playing cards is further comprised of at least one green free card that can be used to substitute for another green card in the plurality of playing cards.

11. The system for teaching mathematics of claim 10 wherein the plurality of playing cards is further comprised of at least one red free card that can be used to substitute for another red card in the plurality of playing cards.

12. A method of teaching, comprising:
a plurality of representations; and,
a set of rules for combining at least two of the representations whereby the combination of elements formed are representative of a concept being taught.

13. The teaching method of claim 12 wherein:
the plurality of representations is comprised of a plurality of playing cards representing trigonometric functions;
the set of rules for combining at least two of the representations is further comprised of:
laying the playing cards next to each other from left to right representing addition;
laying the playing cards above and below each other representing subtraction;
laying the playing cards on top of each other in a parallel configuration to represent multiplication;
laying the playing cards on top of each other in a perpendicular configuration to represent division; and,
the concepts being taught comprised of trigonometric functions and trigonometric identities.

14. A card game, comprising:
a plurality of cards;
a set of rules whereby the cards may be combined to equal other cards; and,
a set of rules whereby the cards may be combined to earn points.

15. The card game of claim 14 wherein the plurality of cards is comprised of:
green cards;
red cards; and,
red and green cards:
wherein the green cards are further comprised of:
at least two cards with a green ellipse on a white background;
at least two cards with two green ellipses on a white background;
at least two cards with a white ellipse on a green background; and,
at least two cards with two white ellipses on a green background;
wherein the red cards are further comprised of:
at least two cards with a red triangle on a white background;
at least two cards with two red triangles on a white background;
at least two cards with a white triangle on a red background; and,
at least two cards with two white triangles on a red background;
wherein the red and green cards are further comprised of:
at least two cards with a green ellipse and a red triangle, wherein the red triangle is pointed down and is below the green ellipse, on a white background;
at least two cards with two green ellipses and two red triangles, wherein the two red triangles are pointed down and are below the green ellipses, on a white background;
at least two cards with a green ellipse and a red triangle, wherein the red triangle is pointed down and is above the green ellipse, on a white background; and,
at least two cards with two green ellipses and two red triangles, wherein the two red triangles are pointed down and are above the green ellipses, on a white background.

16. The card game of claim 15 wherein the set of rules whereby the cards may be combined to equal other cards is further comprised of:
a first card with a green ellipse on a white background can be laid on top of a second card of the same equals a card with two green ellipses on a white background;
a first card with a white ellipse on a green background can be laid on top of a second card of the same equals a card with two white ellipses on a green background;
a first card with a red triangle on a white background can be laid on top of a second card of the same equals a card with two red triangles on white background;
a first card with a white triangle on a red background can be laid on top of a second card of the same equals a card with two white triangles on red background;
a first card with a green ellipse and a red triangle, wherein the red triangle is pointed down and is below the green ellipse, on a white background can be laid on top of a second card of the same equals a card with two green ellipses and two red triangles, wherein the red triangles are pointed down and are below the green ellipses; and,
a first card with a green ellipse and a red triangle, wherein the red triangle is pointed down and is above the green ellipse, on a white background, can be laid on top of a second card of the same equals a card with two green ellipses and two red triangles, wherein the red triangles are pointed down and are above the green ellipse.

17. The card game of claim 16 wherein the plurality of cards is further comprised of:
at least one card with the words FREE GREEN CARD;
at least one card with the words FREE RED CARD; and,
at least one card with the words FREE CARD.

18. The card game of claim 17 wherein the set of rules whereby the cards may be combined to equal other cards is further comprised of:
a FREE GREEN CARD equals any green card;
a FREE RED CARD equals any red card; and,
a FREE CARD equals any card.

19. The card game of claim 18 wherein the set of rules whereby the cards may be combined to earn points is further comprised of:
a card combination of any two identical cards wherein a first card placed on top of a second card of the same in a crossed configuration earns one point;
a card combination of any one card wherein the one card is any card from the group of cards consisting of FREE GREEN CARDs, FREE RED CARDs, and FREE CARDs;
a card combination of two cards wherein a first card is a green card with a green background and a second card is a green card with a white background and the first card and the second card display the same shape and the same number of shapes and the second card is placed on top of the first card in a parallel configuration earns two point.
a card combination of two cards wherein a first card is a red card with a red background and a second card is red card with a white background and the first card and the second card display the same shape and the same number of shapes and the second card is placed on top of the first card in a parallel configuration earns two point;
a card combination of two cards wherein a first card is a card with a green ellipse and a red triangle, wherein the red triangle is pointed down and is below the green ellipse, on a white background and a second card is a card with a green ellipse and a red triangle, wherein the red triangle is pointed down and is above the green ellipse and the second card is placed on top of the first card in a parallel configuration earns two points;
a card combination of any two cards wherein the two cards are any cards from the group of cards consisting of FREE GREEN CARDs, FREE RED CARDs, and FREE CARDs, the two cards placed side by side earns two points;
a card combination of two cards wherein a first card is a card with two green ellipses on a white background, and a second card is a card with two red triangles on a white background and the second card is placed to the right side of the first card earns three points;
a card combination of two cards wherein a first card is a card with two white triangles on a red background, and a second card is a card with two green ellipses and two red triangles, wherein the two red triangles are pointed down and are below the green ellipses on a white background and the second card is placed below the first card earns three points;
a card combination of two cards wherein a first card is a card with two white ellipses on a green background, and a second card is a card with two green ellipses and two red triangles, wherein the two red triangles are pointed down and are above the green ellipses on a white background and the second card is placed below the first card earns three points;
a card combination of any three cards wherein the three cards are any cards from the group of cards consisting of FREE GREEN CARDs, FREE RED CARDs, and FREE CARDs, the three cards placed side by side earns three points;
a card combination of four cards comprised of two combinations placed side by side wherein the first combination is comprised of two cards wherein a first card is a card with two green ellipses on a white background and a second card is a card with two red triangles on a white background and the second card is placed to the right side of the first card and the second combination is comprised of any two identical cards wherein a first card is placed above a second card earns four points;
a card combination of four cards comprised of two combinations placed side by side wherein the first combination is comprised of two cards a first card is a card with two white ellipses on a green background and a second card is a card with two green ellipses and two red triangles, wherein the two red triangles are pointed down and are below the green ellipses on a white background and the second card is placed below the first card and the second combination is comprised of any two identical cards wherein a first card is placed above a second card earns four points;
a card combination of four cards comprised of two combinations placed side by side wherein the first combination is comprised of two cards a first card is a card with two white ellipses on a green background and a second card is a card with two green ellipses and two red triangles, wherein the two red triangles are pointed down and are above the green ellipses on a white background and the second card is placed below the first card and the second combination is comprised of any two identical cards wherein a first card is placed above a second card earns four points; and,
a card combination of any four cards wherein the four cards are any cards from the group of cards consisting of FREE GREEN CARD, FREE RED CARD, and FREE CARD, the four cards placed side by side earns four points.

20. The card game of claim 19 wherein the plurality of playing cards is made of one or more materials from the group of materials consisting of paper, laminated paper, wood, metal, and plastic.
